(19) United States
(12) Patent Application Publication
(10) Pub. No.: US 2025/0245903 A1
(43) Pub. Date: Jul. 31, 2025

(54) THREE-DIMENSIONAL (3D) SCENE RECONSTRUCTION (3DR) REFINEMENT AND FUSION FROM MULTIPLE 3DR ALGORITHM INPUTS

(71) Applicant: QUALCOMM Incorporated, San Diego, CA (US)

(72) Inventors: Gokce DANE, San Diego, CA (US); Pirazh KHORRAMSHAHI, San Diego, CA (US); Adithya Reddy NALLABOLU, San Diego, CA (US); Mehul ARORA, La Jolla, CA (US); Upal MAHBUB, Santee, CA (US)

(21) Appl. No.: 18/425,959

(22) Filed: Jan. 29, 2024

(51) Int. Cl. G06T 15/04; G06T 3/4046; G06T 7/11; G06T 7/55

(52) U.S. Cl. CPC G06T 15/04; G06T 3/4046; G06T 7/11; G06T 7/55; G06T 2207/20081; G06T 2207/20084

(57) ABSTRACT

Techniques and systems are provided for image processing. For instance, a process can include generating a set of surface representation values for one or more surfaces visible in one or more first images using a first three dimensional scene reconstruction (3DR) algorithm; preprocessing the set of surface representation values to generate preprocessing information for a second 3DR algorithm; generating, by the second 3DR algorithm, a refined set of surface representation values based on the set of surface representation values and the preprocessing information; and outputting the refined set of surface representation values.

### FIELD

The present application is related to image processing. For example, aspects of the present application relate to systems and techniques for 3D scene reconstruction (3DR) refinement and fusion with multiple 3DR algorithm inputs.

### BACKGROUND

Many devices and systems utilize 3D technology for a wide variety of different use cases, including mobile devices (e.g., mobile phones), extended reality (XR) systems (e.g., virtual reality (VR), augmented reality (AR), and/or mixed reality (MR)), vehicles (e.g., autonomous or semi-autonomous vehicles), robotics systems, among others. Such systems can include sensors that capture frames of data (e.g., image frames or other type of data) of an environment. The data can be used to reconstruct a 3D scene of the environment using a 3D reconstruction (3DR) techniques. In one illustrative example, a virtual environment for an extended reality (XR) system (e.g., a virtual reality (VR) system, an augmented reality (AR) system, and/or mixed reality (MR) system) may be populated based on digital replication of a real world environment. The digital replication of the real world environment can be generated using 3DR techniques, and can be used to model, simulate, change, better understand, etc. the real world environment and/or object(s) in the environment.

3DR techniques can be based on computer vision (CV) algorithms or machine learning models (e.g., deep learning (DL) neural network models). However, CV-based algorithms can have poor quality outputs based on the quality of input depth and machine learning-based 3DR algorithms can be difficult to run in real-time, such as due to large memory and computation constraints based on the large size of machine learning models.

### SUMMARY

Systems and techniques are described herein for image processing. The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, apparatuses, methods and computer-readable media for image processing are provided. In one illustrative example, an apparatus for image processing is provided. The apparatus includes at least one memory; and at least one processor coupled to the at least one memory. The at least one processor is configured to: generate a set of surface representation values for one or more surfaces visible in one or more first images using a first three dimensional scene reconstruction (3DR) algorithm; preprocess the set of surface representation values to generate preprocessing information for a second 3DR algorithm; generate, by the second 3DR algorithm, a refined set of surface representation values based on the set of surface representation values and the preprocessing information; and output the refined set of surface representation values.

As another example, a method for image processing is provided. The method includes: generating a set of surface representation values for one or more surfaces visible in one or more first images using a first three dimensional scene reconstruction (3DR) algorithm; preprocessing the set of surface representation values to generate preprocessing information for a second 3DR algorithm; generating, by the second 3DR algorithm, a refined set of surface representation values based on the set of surface representation values and the preprocessing information; and outputting the refined set of surface representation values.

In another example, a non-transitory computer-readable medium having stored thereon instructions is provided. The instructions, when executed by at least one processor, cause the at least one processor to: generate a set of surface representation values for one or more surfaces visible in one or more first images using a first three dimensional scene reconstruction (3DR) algorithm; preprocess the set of surface representation values to generate preprocessing information for a second 3DR algorithm; generate, by the second 3DR algorithm, a refined set of surface representation values based on the set of surface representation values and the preprocessing information; and output the refined set of surface representation values.

For another example, an apparatus for image processing is provided. The apparatus includes: means for generating a set of surface representation values for one or more surfaces visible in one or more first images using a first three dimensional scene reconstruction (3DR) algorithm; means for preprocessing the set of surface representation values to generate preprocessing information for a second 3DR algorithm; means for generating, by the second 3DR algorithm, a refined set of surface representation values based on the set of surface representation values and the preprocessing information; and means for outputting the refined set of surface representation values.

As another example, an apparatus for image processing is provided. The apparatus includes at least one memory; and at least one processor coupled to the at least one memory. The at least one processor is configured to: generate a first set of surface representation values for one or more surfaces visible in one or more first images using a first three dimensional scene reconstruction (3DR) algorithm; generate a second set of surface representation values for surfaces visible in one or more second images using a second 3DR algorithm, wherein the second 3DR algorithm differs from the first 3DR algorithm; combine, using machine learning model, the first set of surface representation values and second set of surface representation values into a refined set of surface representation values; and output the refined set of surface representation values.

In another example, a method for image processing is provided. The method includes: generating a first set of surface representation values for one or more surfaces visible in one or more first images using a first three dimensional scene reconstruction (3DR) algorithm; generating a second set of surface representation values for surfaces visible in one or more second images using a second 3DR algorithm, wherein the second 3DR algorithm differs from the first 3DR algorithm; combining, using machine learning model, the first set of surface representation values and second set of surface representation values into a refined set of surface representation values; and outputting the refined set of surface representation values.

For another example, a non-transitory computer-readable medium having stored thereon instructions is provided. The instructions, when executed by at least one processor, cause the at least one processor to: generate a first set of surface representation values for one or more surfaces visible in one or more first images using a first three dimensional scene reconstruction (3DR) algorithm; generate a second set of surface representation values for surfaces visible in one or more second images using a second 3DR algorithm, wherein the second 3DR algorithm differs from the first 3DR algorithm; combine, using machine learning model, the first set of surface representation values and second set of surface representation values into a refined set of surface representation values; and output the refined set of surface representation values.

As another example, an apparatus for image processing is provided. The apparatus includes: means for generating a first set of surface representation values for one or more surfaces visible in one or more first images using a first three dimensional scene reconstruction (3DR) algorithm; means for generating a second set of surface representation values for surfaces visible in one or more second images using a second 3DR algorithm, wherein the second 3DR algorithm differs from the first 3DR algorithm; means for combining, using machine learning model, the first set of surface representation values and second set of surface representation values into a refined set of surface representation values; and means for outputting the refined set of surface representation values.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and processing system, in accordance with aspects of the present disclosure.

FIG. 2A is a diagram illustrating an example of a fully-connected neural network, in accordance with some examples of the present disclosure;

FIG. 2B is a diagram illustrating an example of a locally-connected neural network, in accordance with some examples of the present disclosure;

FIG. 2C is a diagram illustrating an example of a convolutional neural network, in accordance with some examples of the present disclosure;

FIG. 2D is a diagram illustrating an example of a deep convolutional network (DCN) for recognizing visual features from an image, in accordance with some examples of the present disclosure;

FIG. 3 is a block diagram illustrating an example deep convolutional network (DCN), in accordance with some examples of the present disclosure;

FIG. 4A is a block diagram illustrating a CV 3DR engine, in accordance with aspects of the present disclosure;

FIG. 4B is an example of a volume block, in accordance with aspects of the present disclosure;

FIG. 5 is a block diagram illustrating a ML 3DR engine, in accordance with aspects of the present disclosure;

FIG. 6 is a block diagram illustrating a technique for 3DR refinement and fusion, in accordance with aspects of the present disclosure;

FIG. 7 is a block diagram illustrating another technique for 3DR refinement and fusion, in accordance with aspects of the present disclosure;

FIG. 8 is a block diagram illustrating another technique for 3DR refinement and fusion, in accordance with aspects of the present disclosure;

FIG. 9 is a flow diagram illustrating a process for processing image data, in accordance with aspects of the present disclosure;

FIG. 10 is a flow diagram illustrating a process for processing image data, in accordance with aspects of the present disclosure;

FIG. 11 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

The generation of three-dimensional (3D) models for physical objects can be useful for many systems and applications, such as for extended reality (XR) (e.g., including augmented reality (AR), virtual reality (VR), mixed reality (MR), etc.), robotics, automotive, aviation, 3D scene understanding, object grasping, object tracking, in addition to many other systems and applications. In AR environments, for example, a user may view images (also referred to as frames) that include an integration of artificial or virtual graphics with the user's natural surroundings. AR applications allow real images to be processed to add virtual objects to the images or to display virtual objects on a see-through display (so that the virtual objects appear to be overlaid over the real-world environment). AR applications can align or register the virtual objects to real-world objects (e.g., as observed in the images) in multiple dimensions. For instance, a real-world object that exists in reality can be represented using a model that resembles or is an exact match of the real-world object. In one example, a model of a virtual airplane representing a real airplane sitting on a runway may be presented by the display of an AR device (e.g., AR glasses, AR head-mounted display (HMD), or other device) while the user continues to view his or her natural surroundings through the display. The viewer may be able to manipulate the model while viewing the real-world scene. In another example, an actual object sitting on a table may be identified and rendered with a model that has a different color or different physical attributes in the AR environment. In some cases, artificial virtual objects that do not exist in reality or are computer-generated copies of actual objects or structures of the user's natural surroundings can also be added to the AR environment.

Performing 3D object reconstruction (e.g., to generate a 3D model of an object, such as a face model) from one or more images can be challenging. Traditionally, 3DR may be performed using computer vision (CV) techniques. Such techniques typically use a depth map (e.g., depth image) along with an input image and pose information to generate a 3D mesh of the scene. In some cases, CV techniques may be sensitive to a quality of the depth map. For example, featureless objects may result in holes in the depth map. In some cases, machine learning (ML) based techniques (e.g., using one or more deep-learning neural network models) may also be used for 3DR. Generally, ML based 3DR techniques can produce high-quality 3D reconstruction results, but may be limited in terms of resolution as compared to CV techniques due to computation and memory limitations, which can limit the achievable quality on devices. Furthermore, ML-based algorithms may require multiple frames as inputs and cannot run real-time on devices due to large memory and/or compute constraints. ML-based models (e.g., neural network models) are also large, in which case running an ML model at inference can have large latencies and can cause devices to consume large amounts of power.

Systems, apparatuses, electronic devices, methods (also referred to as processes), and computer-readable media (collectively referred to herein as “systems and techniques”) are described herein for 3D scene reconstruction (3DR) refinement and fusion with multiple 3DR algorithm inputs. For example, a surface representation for surfaces/objects visible in an image may be generated using a first 3DR algorithm, such as a computer vision based 3DR algorithm. In some cases, the surface representation may be a truncated sign distance function (TSDF). The surface representations from the first 3DR algorithm may be postprocessed, such as by identifying areas of the surface representation values that may be refined. The surface representations and identified areas may be output for processing by a second 3DR algorithm, such as a machine learning based 3DR algorithm. The second 3DR algorithm may generate refined surface presentation values for output.

As another example, a surface representation for surfaces/objects visible in an image may be generated using a first 3DR algorithm, such as a machine learning based 3DR algorithm. Values for the surface representation may be upsampled and output to a second 3DR algorithm for processing, such as a computer vision based 3DR algorithm. The second 3DR algorithm may refine the upsampled surface representation to generate a refined set of surface representation values for output.

In another example, a first surface representation for surfaces/objects visible in an image may be generated using a first 3DR algorithm and a second a surface representation for surfaces/objects visible in an image may be generated using a second 3DR algorithm. The first surface representation and second surface representation may be input to a machine learning model that may combine (e.g., fuse) the first surface representation and second surface representation into a refined set of surface representation values for output.

Various aspects of the application will be described with respect to the figures.

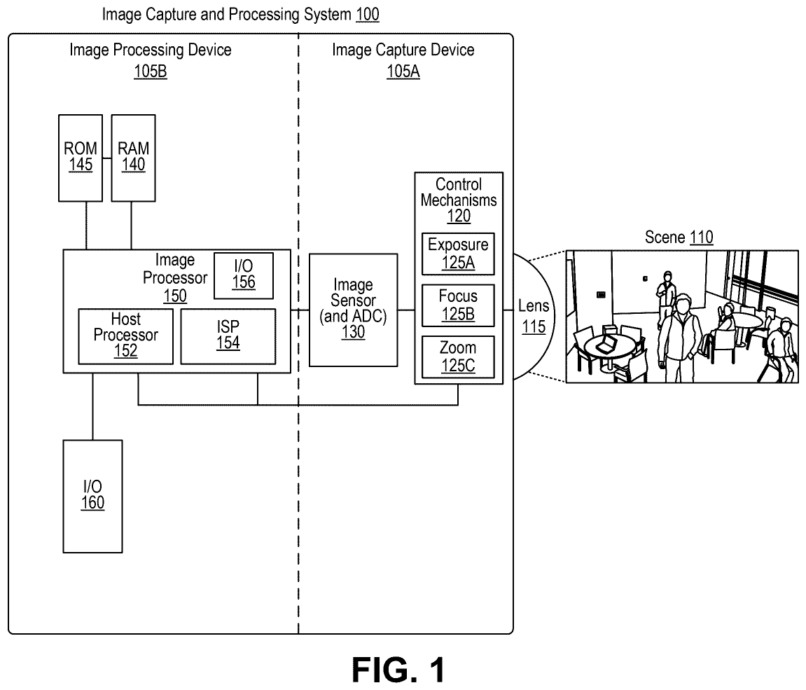

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

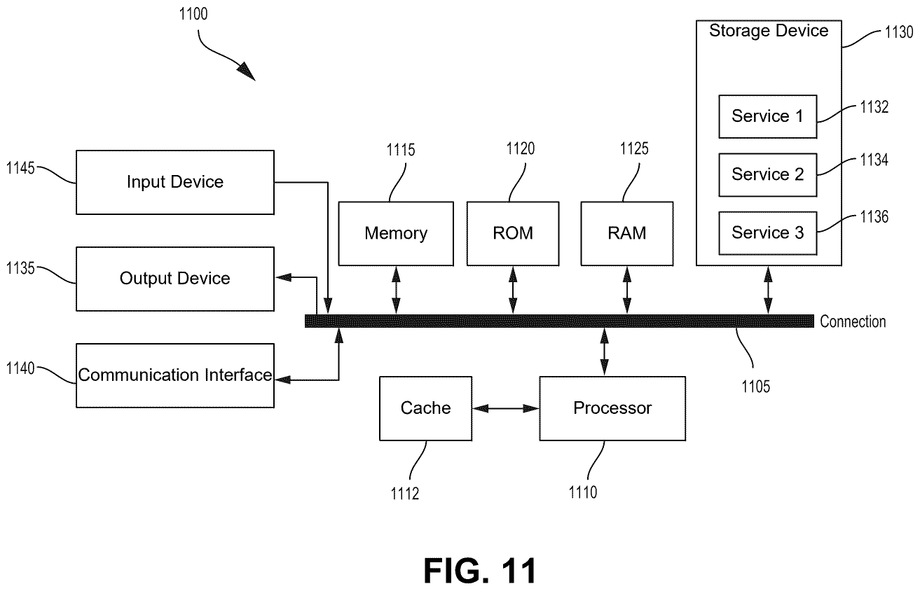

The image processor 150 may include one or more processors, such as one or more image signal processors (ISPs) (including ISP 154), one or more host processors (including host processor 152), and/or one or more of any other type of processor 1110 discussed with respect to the computing system 1100 of FIG. 11. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicking, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.10 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

In some cases, images captured by the image capture and processing system 100 may be processed by neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

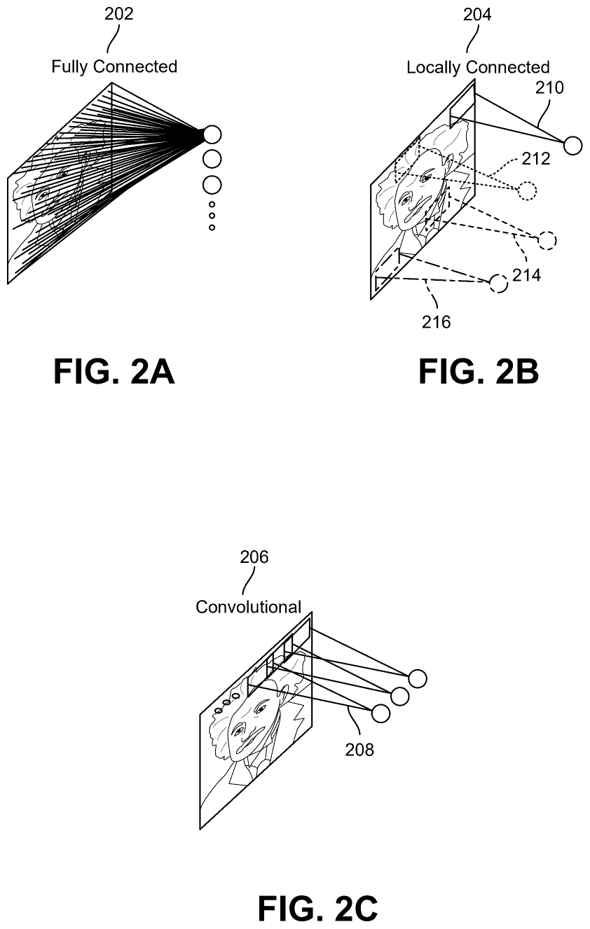

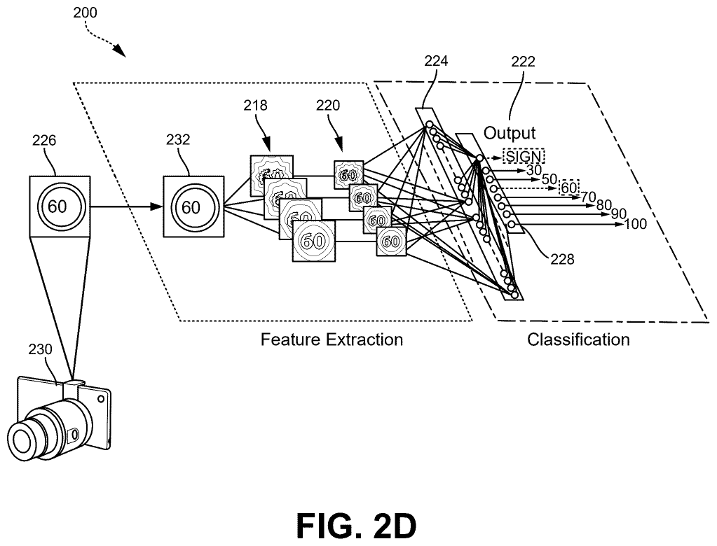

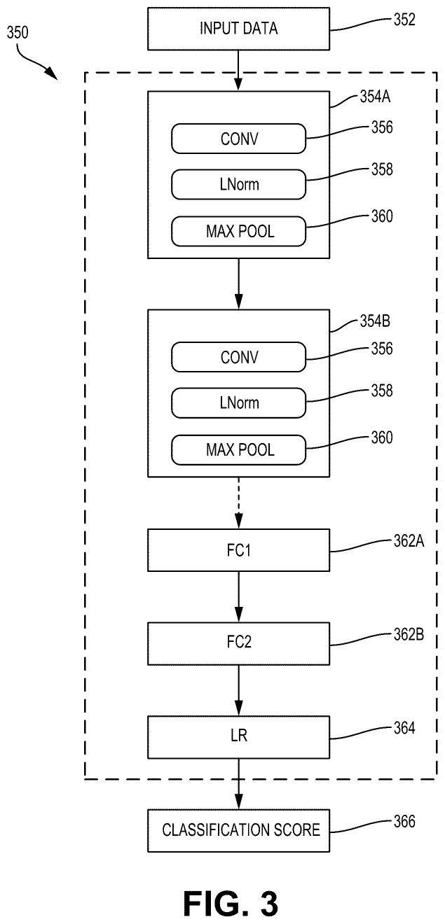

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-FIG. 3.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure.

One type of convolutional neural network is a deep convolutional network (DCN). FIG. 2D illustrates a detailed example of a DCN 200 designed to recognize visual features from an image 226 input from an image capturing device 230, such as a image capture and processing system 100 of FIG. 1. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max (0,x). Values from adjacent neurons may be further pooled, which corresponds to down sampling, and may provide additional local invariance and dimensionality reduction.

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Of note, the layers illustrated with respect to convolution blocks 354A and 354B are examples of layers that may be included in a convolution layer and are not intended to be limiting and other types of layers may be included in any order.

The convolution layers 356 may include one or more convolutional filters, which may be applied to the input data 352 to generate a feature map. Although only two convolution blocks 354A, 354B are shown, the present disclosure is not so limiting, and instead, any number of convolution blocks (e.g., convolution blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a processor such as a CPU or GPU, or any other type of processor 1110 discussed with respect to the computing system 1100 of FIG. 11 to achieve high performance and low power consumption. In alternative aspects, the parallel filter banks may be loaded on a DSP or an ISP of the computing system 1100 of FIG. 11. In addition, the deep convolutional network 350 may access other processing blocks that may be present on the computing system 1100 of FIG. 11, such as sensor processor and navigation module, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362A, 362B, 364 of the deep convolutional network 350 are weights (not shown) that are to be updated. The output of each of the layers (e.g., 356, 358, 360, 362A, 362B, 364) may serve as an input of a succeeding one of the layers (e.g., 356, 358, 360, 362A, 362B, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 350 may output probabilities that an input data, such as an image, includes certain features. The deep convolutional network 350 may then be modified to extract (e.g., output) certain features. Additionally, DCNs may be added to extract other features as well. This set of DCNs may function as feature extractors to identify features in an image. In some cases, feature extractors may be used as a backbone for additionally ML network components to perform further operations, such as image segmentation.

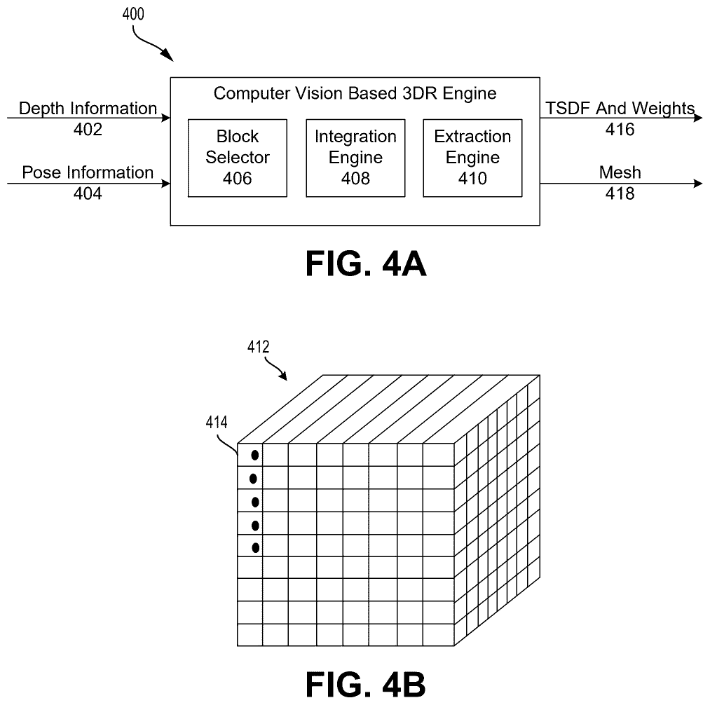

Performing 3D scene reconstruction (e.g., to generate a 3D representation of an environment) from images can be challenging. Traditionally, 3DR may be performed using computer vision (CV) techniques. As used here, CV techniques may refer techniques that do not use machine learning or deep learning, such as depth integration, TSDF fusion, which may compute a 3D representation from a 2D depth map. Such techniques typically use a depth map (e.g., depth image) along with an input image and pose information to generate a 3D mesh of the scene. FIG. 4A is a block diagram illustrating a CV 3DR engine 400, in accordance with aspects of the present disclosure. In some cases, the CV 3DR engine 400 may be implemented, in part or as a whole, in hardware, for example, as one or more circuits, which may be a part of a SoC, processor, etc. In other cases, the CV 3DR engine 400 may be software implemented. The CV 3DR engine 400 may take, as input depth information 402 and pose information 404 for a scene and the CV 3DR engine 400 may include a block selector 406, integration engine 408, and an extraction engine 410. In some cases, the depth information 402 may be monocular depth information (e.g., captured using a single camera) and may be derived, for example, using depth from stereo, ML based depth sensing, etc. The depth information 402 may be a depth map corresponding to a received image. The pose information 404 may be information about a device's location and/or orientation within the environment.

In some cases, the block selector 406 may select 3D spaces visible by the camera that are likely to include objects/surfaces, based on the depth information 402. For example, the block selector 406 may project an image into 3D space, for example, using the depth information and selecting volume blocks in which a pixel may be in based on the depth information. As shown in FIG. 4B, a volume block 412 may be a block of voxels (e.g., voxel 414, which may be 3D pixels for an area of an environment captured by an image), such as an 8×8×8 block of voxels. The block selector 406 may output a list of block indices indicating which blocks likely have object/surfaces in them. The integration engine 408 may, based on the list of block indices, convert the depth information into an implicit surface representation, such as a truncated sign distance function (TSDF).

The TSDF may be a function which measures a distance d for each 3D point or voxel to the closest point on a surface of an object. Positive TSDF values may indicate that a voxel of a volume block is in front of a surface, negative TSDF values may indicate that a voxel of the volume block is within (e.g., behind, inside, etc.) the surface, and a 0 TSDF value may indicate the surface. In some cases, the distance d may be truncated to −1, 1 using a threshold. This threshold may be called a ramp. The TSDF may be determined based on the following equations:

$$tsdf = \{ \begin{matrix}- 1 , & if d \leq - ramp \\ \frac{d}{ramp} , & if - ramp < d < ramp \\ 1 , & if d \geq ramp\end{matrix}$$

$$sample . tsdf = ( \frac{sample . weight * sample . tsdf + tsdf}{sample . weight + 1} ) .$$

In some cases, the block selector 406 may update the TSDF values and weights as images are received from the device. In some cases, the weight may be a counter corresponding to a voxel to track how many times the voxel has been visited. For example, based on the depth and camera position, the block selector may determine which voxels should be visited. During the visit, the voxel's previous TSDF value may be updated based on the depth and camera pose information and the voxel's weight may be added with one. The extraction engine 410 may takes a volume block 412 and generates a mesh, for example, using a marching cubes algorithm, to generate the mesh from the TSDF grid. In some cases, the CV 3DR engine 400 may output the TSDF values and weights 416 per volume block 412 along with the generated mesh 418.

In some cases, CV techniques can produce high quality, high resolution, 3D representations of a scene. For example, a hardware implemented CV technique may be able to provide multiple (e.g., 32, 64, etc.) TSDF values per volume block 412. However, CV techniques may be sensitive to a quality of the depth map. For example, environments may include featureless objects (or other objects with relatively fewer features), such as solid-colored walls, and it may be difficult to obtain depth information across such featureless objects using optical-based depth measurement techniques, such as depth from stereo or monocular depth techniques. In some cases, such featureless objects may result in holes in the depth map. As another example, depth information obtained using indirect techniques such as depth from stereo can be noisy and vary from frame to frame. This noise may result in noisy and/or distortions in the depth map.

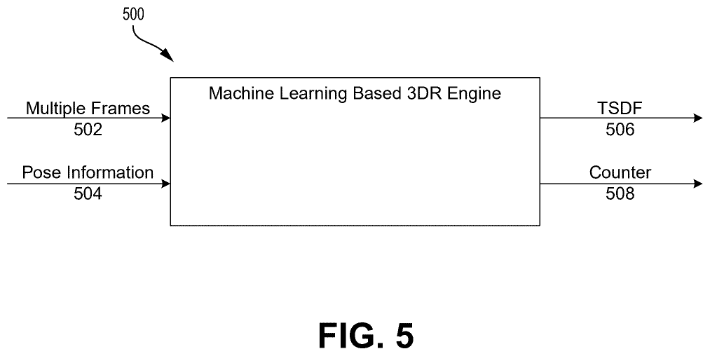

In some cases, machine learning (ML) based techniques may also be used for 3DR. FIG. 5 is a block diagram illustrating a ML 3DR engine 500, in accordance with aspects of the present disclosure. The ML 3DR engine 500 may receive, as input, multiple input images 502 along with pose information 504 corresponding with the multiple input images 502. In some cases, the input images 502 may be grayscale or color images. In some cases, optional input, such as depth information may also be input to the ML 3DR engine 500. The ML 3DR engine 500 may use one or more ML models to construct a 3D space corresponding to the volume (e.g., environment) being reconstructed. In some cases, multiple observations of the scene May be input as multiple input images 502 and corresponding pose information 504. In some cases, the ML 3DR engine 500 may use a set of deep learning feature extractors to detect and extract features from the input images 502 and these features may be back projected based on camera geometry and accumulated into a voxel volume (e.g., volume block). Another ML model(s) (e.g., a second ML model) may be applied on the extracted features to predict a TSDF value for the volume block. Generally, the ML 3DR engine 500 may predict a single TSDF value 506 per volume block for output and possibly a corresponding confidence value. Of note, a size of the volume block (e.g., number of voxels in a volume block) may be adjusted based on a size (e.g., resolution) of the input image(s) for reconstruction. In some cases, the ML 3DR engine 500 may also output a counter value 508. The counter value 508 may be a per volume block indicating how many times that particular volume block was updated based on the extracted features from the multiple frames. In some cases, the second ML model(s) may have learned to predict values for featureless areas, for example, by extrapolating based on areas around the featureless area. In some cases, a weighted average of features from previous predictions may also be used by the second ML model(s) for predicting the TSDF value to update an existing TSDF value (e.g., mesh values may be determined by running the marching cube algorithm on the TSDF values).

Generally, ML based 3DR techniques can produce high-quality 3D reconstruction results, but may be somewhat more limited in terms of resolution as compared to CV techniques. Additionally, ML based 3DR techniques typically take multiple input images and may have relatively large memory constraints (e.g., storing averaged features from previous predictions to be used for future updates) that may make then difficult to execute in real-time on mobile devices at desired resolutions, especially for larger environments. In some cases, ML based 3DR techniques may be able to produce 3D reconstructions for scenes which have noisy depth information and/or sparse features (or featureless). In some cases, a technique that can combine multiple 3DR algorithms to account for the limitations of the individual 3DR algorithms may be useful. Of note, while discussed in the context of CV and ML based 3DR techniques, it should be understood that the techniques discussed herein may be applicable to any 3DR algorithm.

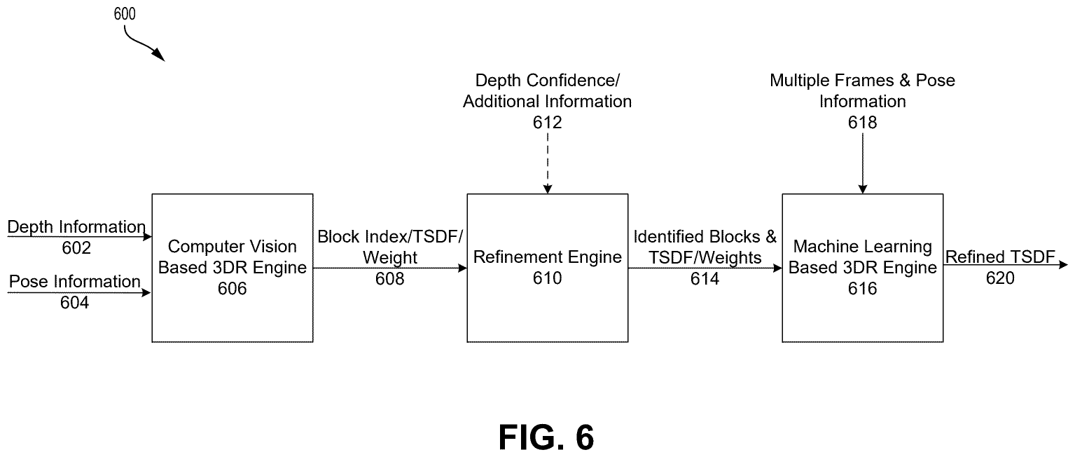

FIG. 6 is a block diagram illustrating a technique for 3DR refinement and fusion 600, in accordance with aspects of the present disclosure. In FIG. 6, depth information 602 and pose information 604 may be passed into a first 3DR engine, such as CV 3DR Engine 606. In some cases, CV 3DR Engine 606 may be similar to CV 3DR engine 400 of FIG. 4A. The CV 3DR Engine 606 may output a set of TSDF values and weights (e.g., confidence value) on a per volume block basis along with a volume block index 608 identifying the volume block being addressed. The set of TSDF values, weights, and volume block index 608 may be input to a refinement engine 610 for preprocessing.

In some cases, the refinement engine 610 may identify areas of the 3D volume (e.g., portions of a scene being reconstructed) which may be refined. In some cases, the weight provided by the CV 3DR Engine 606 may provide an indication of regions of the 3D volume which may be problematic, such as regions which are missing TSDF predictions, may have low quality TSDF predictions, may have input depth map deficiencies, etc. For example, the refinement engine 610 may identify areas (e.g., volume blocks) which are associated with a weight based on a threshold weight. In some cases, the weight may indicate a number of times that a TSDF prediction has been generated for a particular volume block and volume blocks which have had fewer TSDF predictions made may be associated with a lower weight and less predication reliability. For example, a plain, relatively large, wall may be a featureless area. As the wall lacks features, depth information may not have been determined for the wall using depth from stereo techniques. Without the depth information, TSDF predictions may also not have been made for the wall, resulting in a relatively small (e.g., as compared to more feature rich areas of the scene) or zero weight.

In some cases, depth confidence information or other additional information 612 may be provided. For example, a user may provide information about areas of a scene that may benefit from a higher quality/resolution reconstruction, for example, for certain areas/objects within a scene. As another example, additional information such as segmentation maps and/or object information (e.g., from object detection) may be provided. For indoor scenes (e.g., in a room), a majority of the scene may consist of empty space with a small portion of the scene consisting of non-blank surfaces (e.g., not a blank wall) and/or objects. Identifying these areas may help reduce an amount of the scene to perform refinement on using the second 3DR engine. The refinement engine 610 may then identify areas of the scene (e.g., volume block(s)) that may be refined based on the additional information. For example, the refinement engine 610 may identify areas in which more than a threshold number of objects are located near based on the segmentation information or object information.

In some cases, the refinement engine 610 may output 614 an indication of the areas (e.g., identified volume blocks for refinement) that may be refined along with the TSDF and weight information to a second 3DR engine, such as a ML 3DR engine 616. In some cases, the ML 3DR engine 616 may be similar to ML 3DR engine 500 of FIG. 5. The ML 3DR engine 616 may also receive additional image frame(s) and pose information 618. The ML 3DR engine 616 may perform 3DR using the input TSDF, additional image frame(s), and pose information 618 for the identified areas to generate a refined TSDF values for the identified areas. The refined TSDF values may be incorporated into the TSDF values received from the refinement engine 610 into a refined TSDF 620 for output. The refined TSDF 620 may include the TSDF values generated by the CV 3DR Engine 606 along with refined TSDF values generated by the ML 3DR engine 616 for the areas identified by the refinement engine 610.

As the identified areas for refinement should be substantially smaller than an entire scene, the relatively lower TSDF resolution of ML-based 3DR may be mitigated. For example, as discussed above, a ML-based 3DR may generate a single TSDF value per volume block, but the size of the volume block may be based on the size of the area 3DR is being performed on. As a size of the identified areas for refinement may be substantially smaller than a size of an entire scene (e.g., as captured by the input frame(s)), a number of voxels per volume block for refinement in the areas for refinement may be substantially smaller, resulting in a denser set of TSDF values, as compared to performing ML-based 3DR for an entire scene. This denser set of TSDF values allows the ML 3DR engine 616 to provide sufficient granularity of TSDF values to refine the areas identified by the refinement engine 610.

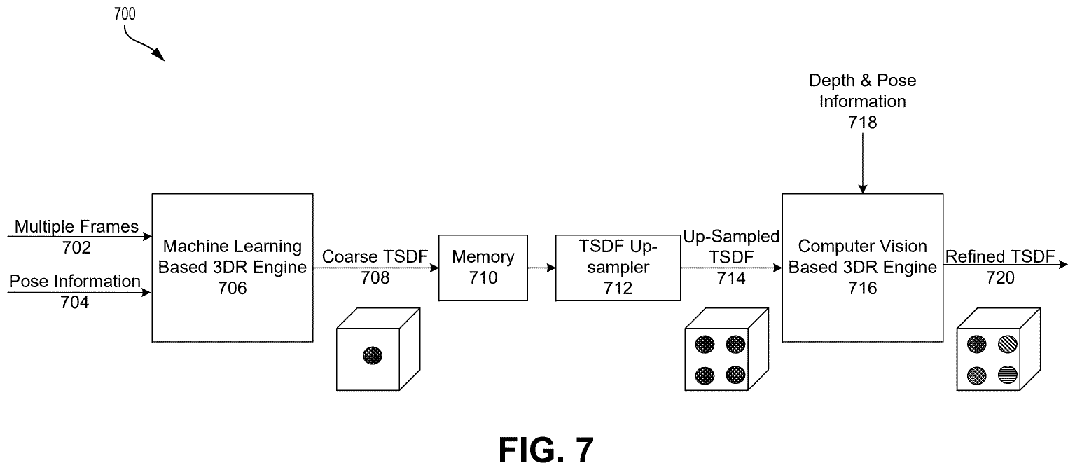

FIG. 7 is a block diagram illustrating another technique for 3DR refinement and fusion 700, in accordance with aspects of the present disclosure. In FIG. 7, multiple input images 702 (e.g., frames) and pose information 504 for those multiple images may be input to a ML 3DR engine 706. In some cases, the ML 3DR engine 706 may be similar to ML 3DR engine 500 of FIG. 5. The ML 3DR engine 706 may generate a coarse TSDF 708 based on the input images 702. For example, the ML 3DR engine 706 may predict a single TSDF value per volume block. The coarse TSDF 708 may be passed to a TSDF upsampler 712 for preprocessing. The TSDF upsampler 712 may upsample the coarse TSDF 708 to a target resolution. For example, the single TSDF value for a volume block may be upsampled to four TSDF values for the volume block. The upsampler 712 may perform a simple upsample which may duplicate the single TSDF value to multiple TSDF values (e.g., 4 voxels by 4 voxels per volume block, 8×8, 16×16, etc.) for the volume block. In some cases, the coarse TSDF 708 may be passed to the TSDF upsampler 712 via a memory 710.

The upsampled TSDF 714 may be passed to a CV 3DR engine 716. The CV 3DR engine 716 may be similar to the CV 3DR engine 400 of FIG. 4A. The CV 3DR engine 716 may also receive pose information and depth information 718 (e.g., a depth map). The CV 3DR engine 716 may integrate the depth information 718 into the voxel blocks to provide finer granularity and details. For example, the CV 3DR engine 716 may perform an update to the upsampled TSDF 714 to incorporate the received depth information 718 to refine the upsampled TSDF 714, which may all be the same value, to independent TSDF values based on the depth information 718. In some cases, refined TSDF values may be filtered, for example, based on the weight value to help select higher quality refined TSDF values to generate the refined TSDF 720. The refined TSDF 720 may then be output.

In some cases, the technique for 3DR refinement and fusion 700 may be adapted for foveated views. Human vision is generally sharpest in a foveal area in a center of a view of an eye and sharpness drops off toward the peripheral areas. A foveated view may be a view of the scene with a sharper part of a scene corresponding to where a user may be looking (e.g., determined based on an eye tracker), with a reduced image quality in the peripheral areas. For scene reconstruction, a higher quality reconstruction may be used for where the user is looking. For example, the coarse TSDF 708 may be determined for an entire scene. A foveal area where the user is looking may be determined, for example, based on information from an eye tracker, and the TSDF values within the foveal area upsampled by the TSDF upsampler 712 and refined by the CV 3DR engine 810. Similarly, a region of interest (ROI) may be determined and TSDF values within the ROI area upsampled by the TSDF upsampler 712 and refined by the CV 3DR engine 810. In some cases, the ROI for higher quality reconstruction (e.g., refinement) may be user designated.

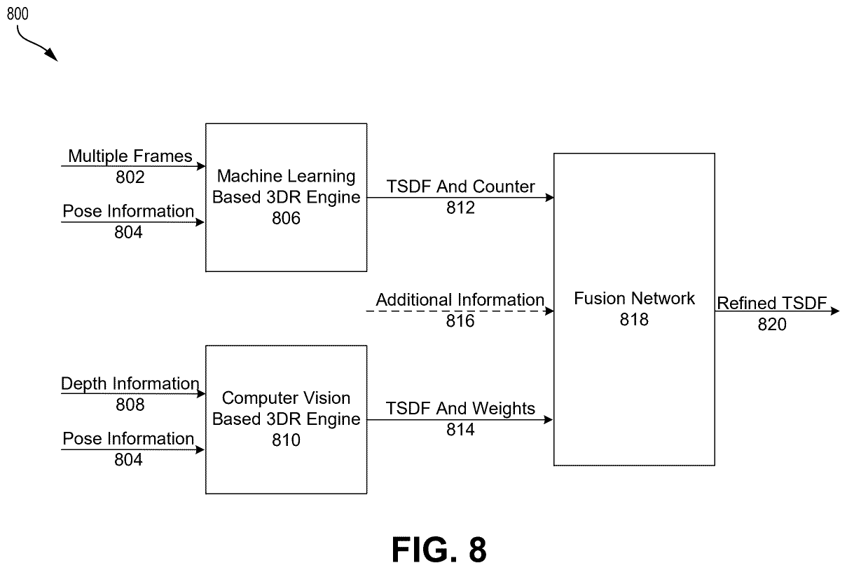

FIG. 8 is a block diagram illustrating another technique for 3DR refinement and fusion 800, in accordance with aspects of the present disclosure. In FIG. 8, multiple input images 802 (e.g., frames) and pose information 804 for those multiple images may be input to a ML 3DR engine 806. In some cases, the ML 3DR engine 806 may be similar to ML 3DR engine 500 of FIG. 5. Depth information 808 and the pose information 804 may be passed into a CV 3DR engine 810. In some cases, CV 3DR engine 810 may be similar to CV 3DR engine 400 of FIG. 4A. The ML 3DR engine 806 and CV 3DR engine 810 may operate substantially in parallel to generate TSDF information. For example, the ML 3DR engine 806 may generate a first TSDF and counter information 812 and the CV 3DR engine 810 may generate a second TSDF and weights 814. The first TSDF and counter information 812 and second TSDF and weights 814 may be passed to a fusion network 818. The fusion network 818 may include one or more ML models, such as a deep learning ML model, CNN, etc. The one or more ML models of the fusion network 818 may be trained to combine (e.g., fuse) the TSDF outputs of the ML 3DR engine 806 the CV 3DR engine 810 into a refined TSDF 820. As an example, the one or more ML models may include a series of CNN layers that process each TSDF input (e.g., the CV-based and the ML-based inputs) initially. The results from the two paths may be further processed using either additional CNN layers or a cross-attention mechanism to learn relationship between the input sources and learn to produce a more refined TSDF 820 result. In some cases, the fusion network 818 may combine (e.g., fuse) the TSDF outputs of the ML 3DR engine 806 the CV 3DR engine 810 by weighting the first TSDF based on the counter information received from the ML 3DR engine 806 and weighting the second TSDF based on the weights received from the CV 3DR engine 810. In some cases, the fusion network 818 may also receive additional information 816, such as additional depth information, segmentation information, object detection information, etc. and this additional information 816 may be used to combine (e.g., fuse) the TSDF values. In some cases, the fusion network 818 may produce combined or fused (e.g., refined) TSDF values at multiple resolutions.

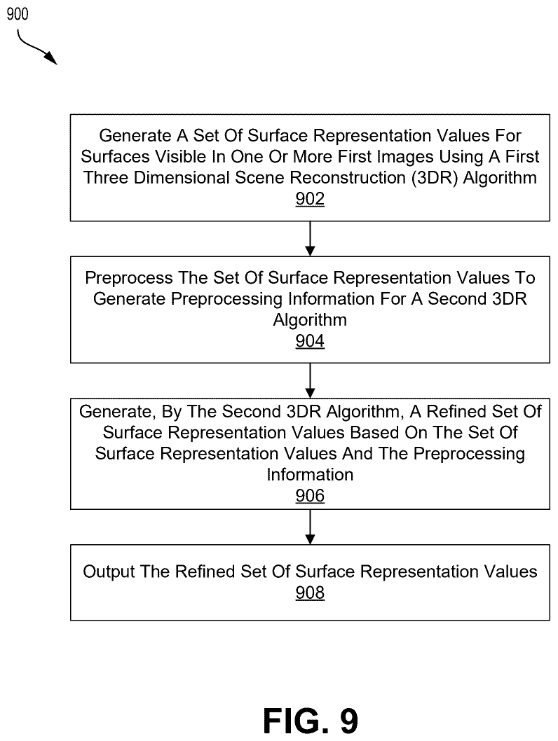

FIG. 9 is a flow diagram illustrating a process 900 for processing image data, in accordance with aspects of the present disclosure. The process 900 may be performed by a computing device (or apparatus) or a component (e.g., a chipset, codec, etc.) of the computing device (e.g., image capturing and processing system 100 of FIG. 1, image capturing device 230 of FIG. 2, computing system 1100 of FIG. 11, etc.). The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 900 may be implemented as software components that are executed and run on one or more processors (e.g., the image processor 150 of FIG. 1, the host processor 152 of FIG. 1, processor 1110 of FIG. 11, and/or other processor(s)). In some cases, the operations of the process 900 can be implemented by a system having the architecture of computing system 1100 of FIG. 11.

At block 902, the computing device (or component thereof) may generate a set of surface representation values (e.g., set of TSDF values, weights, and volume block index 608 of FIG. 6, coarse TSDF 708 of FIG. 7, etc.) for one or more surfaces visible in one or more first images using a first three dimensional scene reconstruction (3DR) algorithm (e.g., by CV 3DR Engine 606 of FIG. 6, ML 3DR engine 706 of FIG. 7, etc.). In some cases, the first 3DR algorithm comprises at least one of a computer vision based 3DR algorithm or a machine learning based 3DR algorithm, and wherein the second 3DR algorithm comprises at least one of a machine learning based 3DR algorithm or a computer vision based 3DR algorithm. In some cases, the second 3DR algorithm differs from the first 3DR algorithm.

At block 904, the computing device (or component thereof) may preprocess (e.g., by refinement engine 610 of FIG. 6, TSDF upsampler 712 of FIG. 7, etc.) the set of surface representation values to generate preprocessing information (e.g., output 614 indication of the areas that may be refined along with the TSDF and weight information up-sampled of FIG. 6, TSDF 714 of FIG. 7, etc.) for a second 3DR algorithm (e.g., by ML 3DR engine 616 of FIG. 6, CV 3DR engine 716 of FIG. 7, etc.). In some cases, the computing device (or component thereof) may preprocess the set of surface representation values by identifying areas of the set of surface representation values that may be refined. In some examples, the first 3DR algorithm generates weight values (e.g., set of TSDF values, weights, and volume block index 608 of FIG. 6) corresponding to areas of the set of surface representation values, and wherein identifying areas of the set of surface representation values that may be refined is based on the weight values. In some cases, identifying areas of the set of surface representation values that may be refined is based on at least one of a segmentation map or object detection information. In some examples, the computing device (or component thereof) may preprocess the set of surface representation values by upsampling (e.g., by TSDF upsampler 712 of FIG. 7) the set of surface representation values generated by the machine learning based 3DR algorithm.

At block 906, the computing device (or component thereof) may generate, by the second 3DR algorithm, a refined set of surface representation values (e.g., refined TSDF 620 of FIG. 6, refined TSDF 720 of FIG. 7, etc.) based on the set of surface representation values and the preprocessing information. In some cases, the computing device (or component thereof) may generate the refined set of surface representation values by generating refined surface representation values based on the upsampled set of surface representation values (e.g., upsampled TSDF 714 of FIG. 7). In some examples, the set of surface representation values comprises a truncated sign distance function (TSDF) values for voxels, the computing device (or component thereof) may upsample the set of surface representation values by upsampling a TSDF value for a voxel to multiple TSDF values for a block of voxels, the computing device (or component thereof) may receive depth information associated with the block of voxels, and the computing device (or component thereof) may generate the refined set of surface representation values by updating the multiple TSDF values for the block of voxels based on the received depth information.

At block 908, the computing device (or component thereof) may output the refined set of surface representation values.

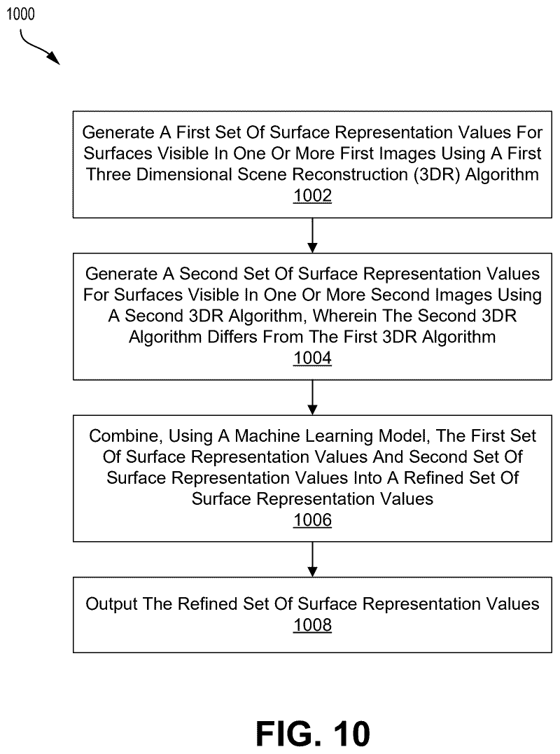

FIG. 10 is a flow diagram illustrating a process 1000 for processing image data, in accordance with aspects of the present disclosure. The process 1000 may be performed by a computing device (or apparatus) or a component (e.g., a chipset, codec, etc.) of the computing device, such as image capturing and processing system 100 of FIG. 1. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1000 may be implemented as software components that are executed and run on one or more processors (e.g., the image processor 150 of FIG. 1, the host processor 152 of FIG. 1, processor 1110 of FIG. 11, and/or other processor(s)). In some cases, the operations of the process 1000 can be implemented by a system having the architecture of computing system 1100 of FIG. 11.

At block 1002, the computing device (or component thereof) may generate a first set of surface representation values (e.g., first TSDF and counter information 812, second TSDF and weights 814 of FIG. 8) for one or more surfaces visible in one or more first images using a first three dimensional scene reconstruction (3DR) algorithm (e.g., by ML 3DR engine 806, CV 3DR engine 810 of FIG. 8). In some cases, the first 3DR algorithm and second 3DR algorithm comprise at least one of a computer vision based 3DR algorithm and a machine learning based 3DR algorithm. In some examples, the set of surface representation values comprises a truncated sign distance function (TSDF) values.

At block 1004, the computing device (or component thereof) may generate a second set of surface representation values (e.g., first TSDF and counter information 812, second TSDF and weights 814 of FIG. 8) for surfaces visible in one or more second images using a second 3DR algorithm (e.g., by ML 3DR engine 806, CV 3DR engine 810 of FIG. 8). In some cases, the second 3DR algorithm differs from the first 3DR algorithm.

At block 1006, the computing device (or component thereof) may combine, using machine learning model, (e.g., by fusion network 818 of FIG. 8) the first set of surface representation values and second set of surface representation values into a refined set of surface representation values (e.g., refined TSDF 820 of FIG. 8). In some cases, the combining is based on counters (e.g., first TSDF and counter information 812 of FIG. 8) received from the first 3DR algorithm and weights (e.g., second TSDF and weights 814 of FIG. 8) received from the second 3DR algorithm. In some examples, the combining is based on at least one of depth information, segmentation information, or object detection information (e.g., additional information 816 of FIG. 8) received by the machine learning model.

At block 1008, the computing device (or component thereof) may output the refined set of surface representation values.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 900, process 1000, and/or other processes described herein may include a processor, microprocessor, micro-computer, or other component of a device that is configured to carry out the steps of the process 900, process 1000, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 900, process 1000, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 900 and process 1000 are illustrated as a logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 900, process 1000, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some examples, computing system 1100 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example computing system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, camera, accelerometers, gyroscopes, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.10 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some examples, a hardware service that performs a particular function can include the software component stored in a computer-readable medium in connection with the necessary hardware components, such as processor 1110, connection 1105, output device 1135, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:

Aspect 1. An apparatus for image processing, comprising: at least one memory; and at least one processor coupled to the at least one memory and configured to: generate a set of surface representation values for one or more surfaces visible in one or more first images using a first three dimensional scene reconstruction (3DR) algorithm; preprocess the set of surface representation values to generate preprocessing information for a second 3DR algorithm; generate, by the second 3DR algorithm, a refined set of surface representation values based on the set of surface representation values and the preprocessing information; and output the refined set of surface representation values.

Aspect 2. The apparatus of Aspect 1, wherein the first 3DR algorithm comprises at least one of a computer vision based 3DR algorithm or a machine learning based 3DR algorithm, and wherein the second 3DR algorithm comprises at least one of a machine learning based 3DR algorithm or a computer vision based 3DR algorithm.

Aspect 3. The apparatus of Aspect 2, wherein, to preprocess the set of surface representation values, the at least one processor is configured to identify areas of the set of surface representation values that may be refined.

Aspect 4. The apparatus of Aspect 3, wherein the first 3DR algorithm generates weight values corresponding to areas of the set of surface representation values, and wherein identifying areas of the set of surface representation values that may be refined is based on the weight values.

Aspect 5. The apparatus of any one of Aspects 3 or 4, wherein identifying areas of the set of surface representation values that may be refined is based on at least one of a segmentation map or object detection information.

Aspect 6. The apparatus of any one of Aspects 2 to 5, wherein, to preprocess the set of surface representation values, the at least one processor is configured to upsample the set of surface representation values generated by the machine learning based 3DR algorithm.

Aspect 7. The apparatus of Aspect 6, wherein, to generate the refined set of surface representation values, the at least one processor is configured to generate refined surface representation values based on the upsampled set of surface representation values.

Aspect 8. The apparatus of any one of Aspects 6 or 7, wherein the set of surface representation values comprises a truncated sign distance function (TSDF) values for voxels, wherein, to upsample the set of surface representation values, the at least one processor is configured to upsample a TSDF value for a voxel to multiple TSDF values for a block of voxels, wherein the at least one processor is configured to receive depth information associated with the block of voxels, and wherein, to generate the refined set of surface representation values, the at least one processor is configured to update the multiple TSDF values for the block of voxels based on the received depth information.

Aspect 9. An apparatus for image processing, comprising: at least one memory; and at least one processor coupled to the at least one memory and configured to: generate a first set of surface representation values for one or more surfaces visible in one or more first images using a first three dimensional scene reconstruction (3DR) algorithm; generate a second set of surface representation values for surfaces visible in one or more second images using a second 3DR algorithm, wherein the second 3DR algorithm differs from the first 3DR algorithm; combine, using machine learning model, the first set of surface representation values and second set of surface representation values into a refined set of surface representation values; and output the refined set of surface representation values.

Aspect 10. The apparatus of Aspect 9, wherein the first 3DR algorithm and second 3DR algorithm comprise at least one of a computer vision based 3DR algorithm and a machine learning based 3DR algorithm.

Aspect 11. The apparatus of any one of Aspects 9 or 10, wherein the combining is based on counters received from the first 3DR algorithm and weights received from the second 3DR algorithm.

Aspect 12. The apparatus of any one of Aspects 9 to 11, wherein the combining is based on at least one of depth information, segmentation information, or object detection information received by the machine learning model.

Aspect 13. The apparatus of any one of Aspects 9 to 12, wherein the set of surface representation values comprises a truncated sign distance function (TSDF) values.

Aspect 14. A method for image processing, comprising: generating a set of surface representation values for one or more surfaces visible in one or more first images using a first three dimensional scene reconstruction (3DR) algorithm; preprocessing the set of surface representation values to generate preprocessing information for a second 3DR algorithm; generating, by the second 3DR algorithm, a refined set of surface representation values based on the set of surface representation values and the preprocessing information; and outputting the refined set of surface representation values.

Aspect 15. The method of Aspect 14, wherein the first 3DR algorithm comprises at least one of a computer vision based 3DR algorithm or a machine learning based 3DR algorithm, and wherein the second 3DR algorithm comprises at least one of a machine learning based 3DR algorithm or a computer vision based 3DR algorithm.

Aspect 16. The method of Aspect 15, wherein preprocessing the set of surface representation values comprises identifying areas of the set of surface representation values that may be refined.

Aspect 17. The method of Aspect 16, wherein the first 3DR algorithm generates weight values corresponding to areas of the set of surface representation values, and wherein identifying areas of the set of surface representation values that may be refined is based on the weight values.

Aspect 18. The method of any one of Aspects 16 or 17, wherein identifying areas of the set of surface representation values that may be refined is based on at least one of a segmentation map or object detection information.

Aspect 19. The method of any one of Aspects 15 to 18, wherein preprocessing the set of surface representation values comprises upsampling the set of surface representation values generated by the machine learning based 3DR algorithm.

Aspect 20. The method of Aspect 19, wherein generating the refined set of surface representation values comprises generating refined surface representation values based on the upsampled set of surface representation values.

Aspect 21. The method of any one of Aspects 19 or 20, wherein the set of surface representation values comprises a truncated sign distance function (TSDF) values for voxels, wherein upsampling the set of surface representation values comprises upsampling a TSDF value for a voxel to multiple TSDF values for a block of voxels and further comprising receiving depth information associated with the block of voxels, and wherein generating the refined set of surface representation values comprises updating the multiple TSDF values for the block of voxels based on the received depth information.

Aspect 22. A method for image processing, comprising: generating a first set of surface representation values for one or more surfaces visible in one or more first images using a first three dimensional scene reconstruction (3DR) algorithm; generating a second set of surface representation values for surfaces visible in one or more second images using a second 3DR algorithm, wherein the second 3DR algorithm differs from the first 3DR algorithm; combining, using machine learning model, the first set of surface representation values and second set of surface representation values into a refined set of surface representation values; and outputting the refined set of surface representation values.

Aspect 23. The method of Aspect 22, wherein the first 3DR algorithm and second 3DR algorithm comprise at least one of a computer vision based 3DR algorithm and a machine learning based 3DR algorithm.

Aspect 24. The method of any one of Aspects 22 or 23, wherein the combining is based on counters received from the first 3DR algorithm and weights received from the second 3DR algorithm.

Aspect 25. The method of any one of Aspects 22 to 24, wherein the combining is based on at least one of depth information, segmentation information, or object detection information received by the machine learning model.

Aspect 26. The method of any one of Aspects 22 to 25, wherein the set of surface representation values comprises a truncated sign distance function (TSDF) values.

Aspect 27: An apparatus for image processing, comprising means for performing one or more of operations according to any of Aspects 14 to 21.

Aspect 28: A non-transitory computer-readable medium having stored thereon instructions that, when executed by at least one processor, cause the at least one processor to perform one or more operations according to any of Aspects 14 to 21.

Aspect 29: An apparatus for image processing, comprising means for performing one or more of operations according to any of Aspects 22 to 26.

Aspect 30: A non-transitory computer-readable medium having stored thereon instructions that, when executed by at least one processor, cause the at least one processor to perform one or more operations according to any of Aspects 22 to 26.

What is claimed is:

1. An apparatus for image processing, comprising:
at least one memory; and
at least one processor coupled to the at least one memory and configured to:
generate a set of surface representation values for one or more surfaces visible in one or more first images using a first three dimensional scene reconstruction (3DR) algorithm;
preprocess the set of surface representation values to generate preprocessing information for a second 3DR algorithm;
generate, by the second 3DR algorithm, a refined set of surface representation values based on the set of surface representation values and the preprocessing information; and
output the refined set of surface representation values.

2. The apparatus of claim 1, wherein the first 3DR algorithm comprises at least one of a computer vision based 3DR algorithm or a machine learning based 3DR algorithm, and wherein the second 3DR algorithm comprises at least one of a machine learning based 3DR algorithm or a computer vision based 3DR algorithm.

3. The apparatus of claim 2, wherein, to preprocess the set of surface representation values, the at least one processor is configured to identify areas of the set of surface representation values that may be refined.

4. The apparatus of claim 3, wherein the first 3DR algorithm generates weight values corresponding to areas of the set of surface representation values, and wherein identifying areas of the set of surface representation values that may be refined is based on the weight values.

5. The apparatus of claim 3, wherein identifying areas of the set of surface representation values that may be refined is based on at least one of a segmentation map or object detection information.

6. The apparatus of claim 2, wherein, to preprocess the set of surface representation values, the at least one processor is configured to upsample the set of surface representation values generated by the machine learning based 3DR algorithm.

7. The apparatus of claim 6, wherein, to generate the refined set of surface representation values, the at least one processor is configured to generate refined surface representation values based on the upsampled set of surface representation values.

8. The apparatus of claim 6, wherein the set of surface representation values comprises a truncated sign distance function (TSDF) values for voxels, wherein, to upsample the set of surface representation values, the at least one processor is configured to upsample a TSDF value for a voxel to multiple TSDF values for a block of voxels, wherein the at least one processor is configured to receive depth information associated with the block of voxels, and wherein, to generate the refined set of surface representation values, the at least one processor is configured to update the multiple TSDF values for the block of voxels based on the received depth information.

9. An apparatus for image processing, comprising:
at least one memory; and
at least one processor coupled to the at least one memory and configured to:
generate a first set of surface representation values for one or more surfaces visible in one or more first images using a first three dimensional scene reconstruction (3DR) algorithm;
generate a second set of surface representation values for surfaces visible in one or more second images using a second 3DR algorithm, wherein the second 3DR algorithm differs from the first 3DR algorithm;
combine, using machine learning model, the first set of surface representation values and second set of surface representation values into a refined set of surface representation values; and
output the refined set of surface representation values.

10. The apparatus of claim 9, wherein the first 3DR algorithm and second 3DR algorithm comprise at least one of a computer vision based 3DR algorithm and a machine learning based 3DR algorithm.

11. The apparatus of claim 9, wherein the combining is based on counters received from the first 3DR algorithm and weights received from the second 3DR algorithm.

12. The apparatus of claim 9, wherein the combining is based on at least one of depth information, segmentation information, or object detection information received by the machine learning model.

13. The apparatus of claim 9, wherein the set of surface representation values comprises a truncated sign distance function (TSDF) values.

14. A method for image processing, comprising:
generating a set of surface representation values for one or more surfaces visible in one or more first images using a first three dimensional scene reconstruction (3DR) algorithm;
preprocessing the set of surface representation values to generate preprocessing information for a second 3DR algorithm;
generating, by the second 3DR algorithm, a refined set of surface representation values based on the set of surface representation values and the preprocessing information; and
outputting the refined set of surface representation values.

15. The method of claim 14, wherein the first 3DR algorithm comprises at least one of a computer vision based 3DR algorithm or a machine learning based 3DR algorithm, and wherein the second 3DR algorithm comprises at least one of a machine learning based 3DR algorithm or a computer vision based 3DR algorithm.

16. The method of claim 15, wherein preprocessing the set of surface representation values comprises identifying areas of the set of surface representation values that may be refined.

17. The method of claim 16, wherein the first 3DR algorithm generates weight values corresponding to areas of the set of surface representation values, and wherein identifying areas of the set of surface representation values that may be refined is based on the weight values.

18. The method of claim 16, wherein identifying areas of the set of surface representation values that may be refined is based on at least one of a segmentation map or object detection information.

19. The method of claim 15, wherein preprocessing the set of surface representation values comprises upsampling the set of surface representation values generated by the machine learning based 3DR algorithm.

20. The method of claim 19, wherein generating the refined set of surface representation values comprises generating refined surface representation values based on the upsampled set of surface representation values.

21. The method of claim 19, wherein the set of surface representation values comprises a truncated sign distance function (TSDF) values for voxels, wherein upsampling the set of surface representation values comprises upsampling a TSDF value for a voxel to multiple TSDF values for a block of voxels and further comprising receiving depth information associated with the block of voxels, and wherein generating the refined set of surface representation values comprises updating the multiple TSDF values for the block of voxels based on the received depth information.

22. A method for image processing, comprising:
generating a first set of surface representation values for one or more surfaces visible in one or more first images using a first three dimensional scene reconstruction (3DR) algorithm;
generating a second set of surface representation values for surfaces visible in one or more second images using a second 3DR algorithm, wherein the second 3DR algorithm differs from the first 3DR algorithm;
combining, using machine learning model, the first set of surface representation values and second set of surface representation values into a refined set of surface representation values; and
outputting the refined set of surface representation values.

23. The method of claim 22, wherein the first 3DR algorithm and second 3DR algorithm comprise at least one of a computer vision based 3DR algorithm and a machine learning based 3DR algorithm.

24. The method of claim 22, wherein the combining is based on counters received from the first 3DR algorithm and weights received from the second 3DR algorithm.

25. The method of claim 22, wherein the combining is based on at least one of depth information, segmentation information, or object detection information received by the machine learning model.

26. The method of claim 22, wherein the set of surface representation values comprises a truncated sign distance function (TSDF) values.
